(19) United States
(12) Patent Application Publication
(10) Pub. No.: US 2026/0145876 A1
(43) Pub. Date: May 28, 2026

(54) CONVEYOR BELT

(71) Applicant: Technological Resources Pty Ltd, Melbourne (AU)

(72) Inventors: John ROBERTSON, Melbourne (AU); Nikhil SAURABH, Melbourne (AU); Yebin SUN, Melbourne (AU)

(73) Assignee: Technological Resources Pty Ltd, Melbourne (AU)

(21) Appl. No.: 19/150,034

(22) PCT Filed: Jan. 23, 2024
(86) PCT No.: PCT/AU2024/050040

§ 371 Date: Jul. 22, 2025

(30) Foreign Application Priority Data
Jan. 23, 2023 (AU) 2023900158

(51) Int. Cl. B65G 15/36

(52) U.S. Cl. CPC B65G 15/36

(57) ABSTRACT

An embodiment of a conveyor belt is disclosed. In one embodiment, the conveyor belt comprises: a middle region having embedded steel cords extending along a longitudinal direction of the conveyor belt; and side regions disposed laterally on either side of the middle region. Each side region has embedded non-steel reinforcing members extending along a longitudinal direction of the conveyor belt. The non-steel reinforcing members have a lower elastic modulus than the steel cords to allow the side regions to absorb in-use stress(es) induced by edge tension through elastic deformation. Related methods of forming a conveyor belt and use of same are also disclosed. A related conveyor belt system is also disclosed.

### FIELD

The present disclosure relates to conveyor belts, such as conveyor belts with steel cords.

### RELATED APPLICATIONS

The present application claims priority to Australian provisional patent application No. 2023900158 filed 23 Jan. 2023, the content of which is incorporated herein by reference in its entirety.

### BACKGROUND

Conveyor systems are used to transport material from one location to another. Most conveyor systems have one or more transition zones where a conveyor belt is transitioned between a flat condition and a troughed condition. During use of conveyor belts, issues such as edge tension cracking and conveyor belt deterioration result from the repeated transition between flat and troughed conditions. Further, whenever there is excessive edge tension in a steel cord conveyor belt, the steel cords on the edges break and result in edge cracks along the length of the belt, requiring pre-mature belt change-out against the standard wear rates. The excessive edge tension may be caused by small curvatures on the conveyor profile, product entrapment between pulley and conveyor belt due to spillage or localised product build-up on pulley, uneven pulley lagging, and short transition length. These issues are hard to resolve as they are typically only addressed during the design and installation phase of the conveyor system.

It is to be understood that, if any prior art publication is referred to herein, such reference does not constitute an admission that the publication forms a part of the common general knowledge in the art, in Australia or any other country.

### SUMMARY

An embodiment provides a conveyor belt comprising: a middle region having embedded steel cords extending along a longitudinal direction of the conveyor belt; and side regions disposed laterally on either side of the middle region, each side region having embedded non-steel reinforcing members extending along a longitudinal direction of the conveyor belt; wherein the non-steel reinforcing members have a lower elastic modulus than the steel cords to allow the side regions to absorb in-use stresses induced by edge tension through elastic deformation.

The induced in-use stresses absorbed by the side regions may be higher than those experienced by the other regions of the conveyor belt.

The in-use stresses induced by the edge tension and absorbed by the side regions may be aligned in the longitudinal and/or transverse directions relative to the conveyor belt.

The non-steel reinforcing members may be non-steel cords. The non-steel cords may be fabric cords. A pitch of the steel cords and the non-steel cords may be the same. A diameter of the steel cords and the non-steel cords may be the same. The non-steel reinforcing members may be polymer-based. The non-steel reinforcing members may comprise materials that are polyester-based, polyamide-based, and/or aramid-based. The non-steel reinforcing members may comprise materials that derive from any of polyester, polyamide, and/or aramid.

The non-steel reinforcing members may each comprise more than one assembly of constituent strands, filaments or fibres of a polymer-based material that are assembled together so as to form a respective non-steel reinforcing member.

The non-steel reinforcing members may comprise more than one or a plurality of first strands assembled together, the or each first strand formed by an assembly of more than one filaments/fibres of material assembled together. In an embodiment, more than one filaments of a material may be assembled together so as to form a respective first strand. In an embodiment, two filaments of a material are assembled together to form a single instance of the first strand. In an embodiment, a measure of the fineness of the or each filament is about 1870 dtex. In an embodiment, assembly of a respective first strand is undertaken in a manner so as to achieve a desired twist degree implemented in a respectively formed first strand. In an embodiment, assembly of both filaments is undertaken so as to implement in a respectively formed first strand a twist degree that is in a range from about 90 twists per metre to about 500 twists per metre. In an embodiment, both filaments are assembled together by way of being twisted together. In an embodiment, one or both of the filaments or fibres are of nylon 66 material.

The non-steel reinforcing members may comprise more than one or a plurality of second strands assembled together, the or each second strand formed by an assembly of more than one of the first strands assembled together. In this manner, more than one strands of the first strand may be used to form a respective second strand, from which a respective non-steel reinforcing member can be formed from. In an embodiment, a plurality of the first strands are assembled together to form a single instance of the second strand. In an embodiment, assembly of a respective second strand is undertaken in a manner so as to achieve a desired twist degree implemented in a respectively formed second strand. In an embodiment, assembly of the plurality of the first strands is undertaken so as to implement in a respectively formed second strand a twist degree that is in a range from about 30 twists per metre to about 300 twists per metre. In an embodiment, assembly of a respective second strand involves ply-twisting the plurality of the first strands together so as to achieve a desired twist degree implemented in a respectively formed second strand.

More than one strands of the second strand may be used to form a respective non-steel reinforcing member. In an embodiment, a plurality of the second strands are assembled together to form a single instance of a respective non-steel reinforcing member. In one embodiment, the assembly of the second strands is undertaken so as to achieve a desired twist degree in a respectively formed non-steel reinforcing member. In an embodiment, assembly of the plurality of the second strands is undertaken so as to implement in a respectively formed non-steel reinforcing member a twist degree that is in a range from about 30 twists per metre to about 300 twists per metre. In one embodiment, the assembly of the plurality of the second strands are double-twisted so as to achieve a desired twist degree in a respectively formed non-steel reinforcing member.

In an embodiment, the or each filament or fibre of the first strand may be treated so as to enable or facilitate structural bonding with a material forming one or more regions of the conveyor belt. In an embodiment, a formed non-steel reinforcing member may be treated (e.g. treatment of its exterior or surface region) so as to enable or facilitate structural bonding with a material forming the regions of the conveyor belt (e.g. a suitable rubber material).

The middle region and the side regions may be formed from rubber. The non-steel reinforcing members in the side regions may be structurally bonded to the rubber. The middle region may have between from about 5 to about 10 times as many steel cords compared to the number of non-steel reinforcing members in each side region. The number of steel cords may range from about 50 to about 100. The number of non-steel reinforcing members may range from about 5 to about 20.

The middle region may occupy from greater than 0% up to about 80% of a width of the conveyor belt. In an embodiment, the middle region may occupy from greater than about 50% up to about 80% of a width of the conveyor belt. Each side region may occupy from greater than 0% up to about 25% of the width of the conveyor belt. In an embodiment, each side region may occupy from about 10% up to about 25% of the width of the conveyor belt. Each side region may comprise an edge section free from non-steel reinforcing members to define an edge width of the conveyor belt. The edge width may occupy from greater than 0% up to about 5% of a width of the conveyor belt, or, in an embodiment, the edge width may occupy from about 15 mm to about 50 mm of a width of the conveyor belt.

The middle region may have a first thickness. The side regions may have a second thickness located at an edge of each side region. The side regions may taper down from the first thickness to the second thickness. The second thickness may range from about 65% to about 85% of the first thickness.

An embodiment provides a conveyor belt comprising: a middle region having a first thickness; and side regions disposed laterally on either side of the middle region having a thickness located at an edge of each side region, the side regions tapering from the first thickness down to the second thickness such that the side regions can withstand higher in-use tension loads compared to the middle region.

The second thickness may be in a range between about 65% to about 85% of the first thickness. The conveyor belt may include the steel cords and non-steel reinforcing members as set forth above.

An embodiment provides a conveyor belt system comprising the conveyor belt as set forth above. An embodiment provides use of the conveyor belt as set forth above to transport material.

An embodiment provides a method of forming a steel cord conveyor belt, comprising:
calculating an in-use tension for each steel cord of a plurality of steel cords, the plurality of steel cords arranged across a width of the conveyor belt;
comparing the tension of each steel cord against a threshold tension value to determine which steel cords of the plurality of cords has a calculated tension that is equal to or above the threshold tension value;
measuring a distance from an edge of the conveyor belt to an inner most steel cord that has a calculated tension equal to or above the threshold tension value and using this distance to define a width of a side region of the conveyor belt.

The method may further comprise embedding steel cords in rubber along a longitudinal direction of the conveyor belt to form a middle region of the conveyor belt positioned between the side regions. The method may further comprise embedding non-steel reinforcing members in rubber along a longitudinal direction of the conveyor belt to define the sides region. The side regions are disposed laterally to the middle region.

The non-steel reinforcing members may have a lower elastic modulus than the steel cords to allow the side regions to absorb higher in-use stresses induced by edge tension through elastic deformation.

An embodiment provides a method of forming a non-steel reinforcing member for use in a steel cord conveyor belt, the method comprising:
forming a first strand by assembling more than one filaments or fibres of a polymer-based material together,
forming a second strand by assembling more than one of the first strands together, and
assembling more than one of the second strands together so as to form a strand of the non-steel reinforcing member.

Forming of the first strand may involve assembling two filaments or fibres of the material together (e.g. by twisting together). In an embodiment, a measure of the fineness of the or each filament is about 1870 dtex. In an embodiment, assembly of both filaments is undertaken so as to implement in a respectively formed first strand a twist degree that is in a range from about 90 twists per metre to about 500 twists per metre. In an embodiment, both filaments are assembled together by way of being twisted together. In an embodiment, one or both of the filaments are of nylon 66 material.

Forming of the second strand may involve assembling a plurality of the first strands together (e.g. by twisting together) to form a single instance of the second strand. In an embodiment, assembly of the plurality of the first strands is undertaken so as to implement in a respectively formed second strand a desired twist degree. In an embodiment, such a twist degree may be in a range from about 30 twists per metre to about 300 twists per metre. In an embodiment, assembly of a respective second strand involves ply-twisting the plurality of the first strands together so as to achieve a desired twist degree implemented in a respectively formed second strand.

In an embodiment, a plurality of the second strands are assembled together (e.g. by twisting together) to form a single instance of a respective non-steel reinforcing member. In an embodiment, assembly of the plurality of the second strands is undertaken so as to implement in a respectively formed non-steel reinforcing member a desired twist degree. In an embodiment, such twist degree may be in a range from about 30 twists per metre to about 300 twists per metre. In one embodiment, the assembly of the plurality of the second strands are double-twisted so as to achieve a desired twist degree in a respectively formed non-steel reinforcing member.

The or each filament of the first strand may be treated (e.g. its exterior or surface region) so as to enable or facilitate structural bonding with a material forming one or more regions of the conveyor belt (e.g. a suitable rubber material).

A respective formed non-steel reinforcing member (e.g. its exterior or surface region) may be treated so as to enable or facilitate structural bonding with a material forming the regions of the conveyor belt (e.g. a suitable rubber material).

An embodiment provides a method of forming a conveyor belt comprising more than one steel reinforcing members, the method comprising:
incorporating with the conveyor belt one or more non-steel reinforcing members each having:
   an assembly of more than one first strands of a polymer-based material, one or more of the first strands formed so as to have a twist degree that is in a range from about 90 twists per metre to about 500 twists per metre, and
   an assembly of more than one second strands formed from an assembly of more than one of the first strands, one or more of the second strands formed so as to have a twist degree that is in a range from about 30 twists per metre to about 300 twists per metre.

Various embodiments described herein can be practiced alone or combination with one or more of the other aspects, as will be readily appreciated by those skilled in the relevant art. The various aspects can optionally be provided in combination with one or more of the optional features described in relation to the other aspects. Furthermore, optional features described in relation to one example (or embodiment) can optionally be combined alone or together with other features in different examples or embodiments.

For the purposes of summarising the aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

The present disclosure will now be described, by way of example only, with reference to the accompanying non-limiting drawings, in which:

FIGS. 1 and 2 are schematic cross-sectional views of an embodiment of a conveyor belt.

FIG. 3 is a schematic cross-sectional view of another embodiment of a conveyor belt.

FIG. 4 is a schematic graph of a relationship between in-use stress and dimensions of a conveyor belt.

FIG. 5 shows a schematic representation of the constituency of one embodiment of a non-steel cord.

FIG. 6 shows tabulated data from a testing exercise involving standard steel cord conveyor belt samples and embodiments of a conveyor belt arranged consistent with the principles described herein.

### DETAILED DESCRIPTION

Embodiments of a conveyor belt will now be described with reference to the Figures. It should be appreciated that the Figures are exemplary only and are not drawn to scale, and only used to describe the features of one or more embodiments.

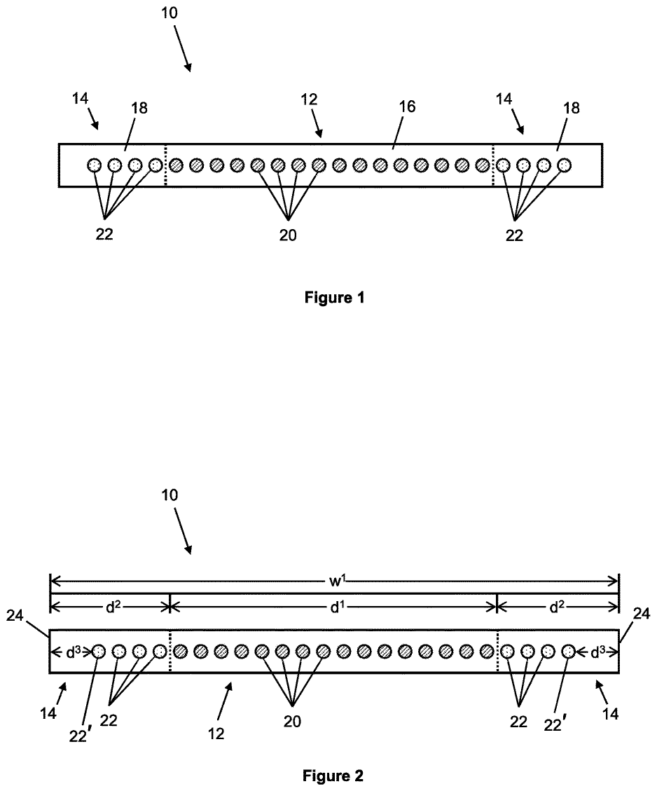

As best shown in FIG. 1, conveyor belt 10 has a middle region in the form of central portion 12. The conveyor belt 10 also has side regions in the form of side portions 14 that are positioned laterally on either side of the central portion 12. The central portion 12 is formed from rubber segment 16 and the side portions 14 are formed from rubber segment 18. In an embodiment, the central portion 12 and side portions 14 are integral. Put another way, the rubber segment 16 and rubber segments 18 are integral, for example, they may be formed simultaneously during curing of rubber during formation of the conveyor belt 10.

The central portion 12 has a plurality of steel cords 20 embedded therein. The steel cords 20 extend along a longitudinal direction of the conveyor belt 10 parallel to one another. The longitudinal direction in FIG. 1 and FIG. 2 extends in a direction into the page. The side portions 14 each have non-steel reinforcing members embedded therein and extend along a longitudinal direction of the conveyor belt 10 parallel to one another. In the embodiment shown in FIG. 1 and FIG. 2, the non-steel reinforcing members are in the form of non-steel cords, specifically fabric cords 22. However, the non-steel reinforcing members could also be embodied in other forms, such as strips or other non-circular reinforcing members.

The steel cords 20 have a first elastic modulus and the fabric cords 22 have a second elastic modulus. In an embodiment, the first elastic modulus is higher than the second elastic modulus such that the fabric cords 22 in the side portions 14 can absorb higher in-use stresses induced by edge tension through elastic deformation of the conveyor belt 10. The induced in-use stresses absorbed by the side portions 14 may be higher than those experienced by the other regions of the conveyor belt 10, for example, the central portion 12. In this way, the fabric cords 22 help to reduce the amount of tension in the side portions 14 during the transition between flat and troughed conditions, which may help to reduce or eliminate issues such as edge tension cracking, conveyor belt deterioration, and hysteresis loss in the side portions 14. In an embodiment, the first elastic modulus is about 6 to about 11 times that of the second elastic modulus. In general, the central portion 12 carries the load and the side portions 14 act in a supporting role to maintain a width and consistency of the conveyor belt 10. The in-use stresses induced by the edge tension which can be absorbed by the fabric cords 22 in the side portions 14 may be aligned in the longitudinal and or transverse directions relative to the in-use orientation of the conveyor belt 10.

Although the conveyor belt 10 includes non-steel cords, it can be considered a steel cord conveyor belt or hybrid steel cord conveyor belt.

In an embodiment, a pitch (i.e. spacing) of adjacent steel cords 20 and fabric cords 22 is the same. Having the same or similar pitch can help to maintain tracking properties during use of the conveyor belt 10. Having the same or similar pitch can also help to maintain a carcass thickness across a width of the conveyor belt 10. It should be appreciated that in an embodiment the pitch of the steel cords and fabric cords 22 may be different and that the disclosure is not limited to a uniform pitch. A diameter of the steel cords 20 and fabric cords 22 may range from about 4 mm to about 7 mm. In an embodiment, a diameter of the steel cords 20 and fabric cords 22 substantially match.

In an embodiment, the fabric cords 22 are bonded to the rubber segment 18 of each side portion 14. The bond between each fabric cord 22 and the rubber segment 18 is structural such that in an embodiment the bond does not split or lose its adhesiveness, and does not crack/fracture during operation. In an embodiment, the fabric cord 22 may be structurally and/or chemically bonded to the rubber segment 18. In an embodiment, the fabric cords 22 are polymer-based. In this manner, the fabric cords 22 could comprise materials or constituents that are polyester-based, polyamide-based, aramid-based, or comprise a composite involving materials that derive respectively from a polyester, a polyamide, and/or an aramid. Polymer-based (e.g. polyester-based, polyamide-based, aramid-based) cords may provide improved bonding to the rubber segment 18 compared with non-polymer-based cords. However, use of bonding agents may be used to help bond the fabric cords 22 to the rubber segment 18. For example, the fabric cords 22 may be pre-treated with a bonding agent prior to embedding into the rubber segment 18.

In the Figures, the number of steel cords 20 and fabric cords 22 is exemplary only and is not limited to the number of steel cords 20 and fabric cords 22 depicted in the Figures. In an embodiment, the central portion 12 has between from about 5 to about 10 times as many steel cords compared to the number of non-steel cords in each side portion 14. For example, the number of steel cords 20 may range from about 50 to about 100, and the number of fabric cords 22 may range from about 5 to about 20. In an embodiment, the central portion 12 has about 89 steel cords 20 and each side portion 14 has about 13 fabric cords.

The tensile strength of the conveyor belt 10 is dependent, in part, on the tensile strength of cords in the carcass e.g. cords 20 and 22. Generally, the rubber used to form segment 16 or 18 has a lower elastic modulus than the elastic modulus of the steel cords 20 and fabric cords 22. Therefore, the elastic properties of the central portion 12 and side portions 14 are determined, respectively, by the elastic modulus of the steel cords 20 and fabric cords 22. In an embodiment, each of the fabric cords 22 have the same elastic modulus. However, in an alternative embodiment, each of the fabric cords 22 have different elastic properties such that the outermost fabric cord is the most elastic and each adjacent fabric cord 22 has a decreased elasticity such that the innermost fabric cord 22 is the least elastic of the fabric cords 22.

The conveyor belt 10 may have an equal top cover thickness and bottom cover thickness. Alternatively, a top cover thickness and bottom cover thickness may be unequal.

A protection layer may be embedded into the conveyor belt 10 (not shown). The protection layer may help the conveyor belt 10 to have better impact resistant properties. In an embodiment, the protection layer has a thickness of about 2-3 mm. The protection layer may be a “Breaker” protection layer. The protection layer may be formed from fabric-and/or steel-based.

Spatial relationships of the features of the conveyor belt 10 will now be described with reference to FIG. 2. The central portion 12 has a width d¹ that occupies greater than from 0% up to about 80% of a width w¹ of the conveyor belt 10. In an embodiment, width d¹ of the central portion 12 ranges from about 50% to about 80% of conveyor belt width w¹. In an embodiment, width d¹ of the central portion 12 ranges from about 70% to about 80% of conveyor belt width w¹. In an embodiment, width d¹ of the central portion 12 is approximately 1360 mm.

The side portions 14 each have a width d² of greater than from 0% up to about 15% of conveyor belt width w¹. In an embodiment, width d² of each side portion 14 ranges from about 10% to about 25% of conveyor belt width w¹. In an embodiment, width d² of each side portion 14 ranges from about 15% to about 25% of conveyor belt width w¹. In an embodiment, width d² of each side portion 14 ranges from about 15% to about 20% of conveyor belt width w¹. In an embodiment, width d² of each side portion 14 ranges from about 8% to about 12% of conveyor belt width w¹. In an embodiment, width d² of each side portion 14 is about 10% of conveyor belt width w¹. In an embodiment, width d² of each side portion 14 is approximately about 218 mm.

The width d² of each side portion 14 is generally selected to ensure the side portions 14 can withstand higher in-use tension loads compared to the central portion 12. More specifically, the side portions 14 are designed around the width of the typical location/area(s) of the higher stresses due to an outside of the conveyor belt 10 having to travel further than the central portion 12 during conveyor belt transitions. For example, and with reference to FIG. 4, if it is determined that in use an all-steel corded conveyor belt has steel cords that experience tension above a threshold value (Vₜ), the width d² of each side portion 14 can be determined by the intersection point 100 of the calculated stress and the threshold value Vt.

Accordingly, an embodiment may provide a method of forming a steel cord conveyor belt. The method may include: calculating an in-use tension for each steel cord of a plurality of steel cords that are arranged across a width (w¹) of the conveyor belt 10; comparing the tension of each steel cord against a threshold tension value (i.e. Tᵥ) to determine which steel cords of the plurality of cords has a calculated tension that is equal to or above the threshold tension value; measuring a distance from an edge of the conveyor belt to an inner most steel cord that has a calculated tension equal to or above the threshold tension value to and using this distance to define a width (i.e. d²) of the side portion 14 of the conveyor belt 10.

Once the width d² is calculated, the conveyor belt 10 may be formed. In an embodiment, the method of forming the conveyor belt may comprise embedding steel cords 20 in rubber segment 16 to form the central portion 12 of the conveyor belt 10 and embedding non-steel reinforcing members such as fabric cords 22 in rubber segment 18 to define the sides regions 14. The method may comprise curing or vulcanising the rubber to embed the steel cords 20 and fabric cords 22.

The threshold value Vₜ is generally determined by a % load rating of the steel cords in the central portion 12. For example, for a conveyor belt having ST1600, a threshold value may be about 240 N/mm which represents a local tension of about 115% of rating.

The conveyor belt 10 also has an edge section free from non-steel reinforcing members to define an edge width of the conveyor belt. The edge section is shown in FIG. 2 as edge width d³ (shown between edge 24 and a fabric cord identified as 22′ in FIG. 2). In an embodiment, the edge width d³ occupies from greater than 0% up to about 50% of a width of the conveyor belt 10. In an embodiment, the edge width d³ occupies from about 15 mm to about 50 mm of a width of the conveyor belt 10. For example, the edge width d³ may be from about 25 mm to about 30 mm. In an embodiment, the edge width d³ is about 28 mm.

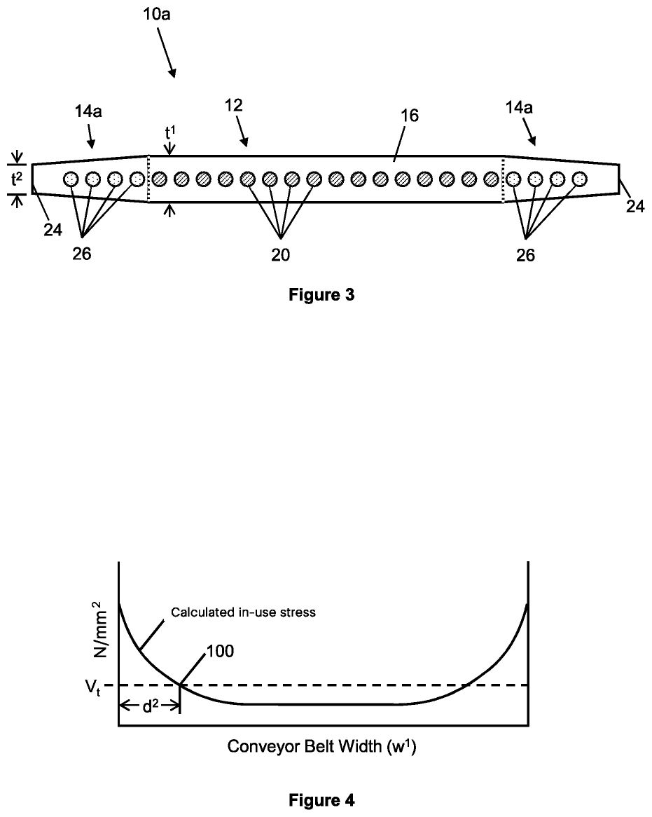

In an embodiment, and as best seen in FIG. 3, the central portion 12 of conveyor belt 10a has a first thickness t¹, and the side portions 14 each have an edge 24 having a second thickness t², where t¹>t². The side portions 14 taper from the first thickness t¹ at a boundary of the side portion 14 and the central portion 12 down to the second thickness t². In an embodiment, the second thickness t² ranges from about 65% to about 85% of the first thickness t¹. In an embodiment, the second thickness t² ranges from about 70% to about 80% of the first thickness t¹. For example, the first thickness t¹ may be about 19 mm and the second thickness t² may be about 14 mm.

On conveyor systems that have high tension bend pulleys, the conveyor belt can be subject to differential wear across the conveyor during use that results in the conveyor belt having a differential thickness across a width of the conveyor belt. Incorporating a differential thickness on the conveyor belt 10a may help to take into consideration the wear over time and longer travel times/distance of the more laterally positioned cords. In conveyor belt 10a, the cords 26 in the side portions 14a may be steel cords. Alternatively, the cords 26 in the side portions 14a may be fabric cords e.g. fabric cords 22 (one embodiment of such a fabric cord 22 is described below).

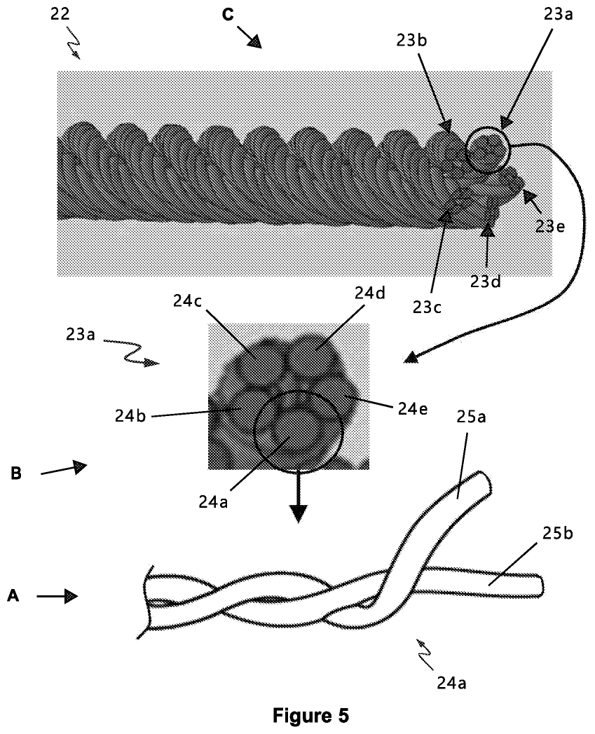

One embodiment of the construction of a fabric cord 22 consistent with the principles of the present disclosure is described below with reference to FIG. 5, which shows a schematic representation of the constituency of the embodiment of the fabric cord 22.

For the embodiment shown in FIG. 5, the fabric cords 22 each comprise assemblies of strands/filaments of a selected material that are assembled together in a twisted (or helical like) manner. The fabric cord 22 is shown having a constituency involving multiple first strands 24 (i.e., first strands 24a-24e each being a composite of filaments 25a, 25b) and multiple second strands 23 (i.e., second strands 23a-23e, each being a composite of the first strands 24a-24e). The constituency of the fabric cord 22 can be formed as a composite of both polyester and/or polyamide-based materials.

As shown at the lower portion (schematic “A”) of FIG. 5, a single strand of the first strand 24 (first strand 24a shown specifically) is formed by way of two filaments 25a, 25b of a polymer-based material (e.g. of polyester and/or polyamide derivation) being assembled together. For the embodiment shown, each of the filaments 25a, 25b have a fineness of approximately 1870 dtex (being a measure of fibre or filament fineness often used in the case of polymer-based fibres or filaments). The formed first strand 24 may be described in the form “1870 dtex/2”. For the embodiment shown, each first strand 24 is formed by way of the filaments 25a, 25b being assembled together in a manner (e.g. by twisting together) so as to implement in the respectively formed first strand 24 a twist degree that is in a range from about 90 twists per metre (or T/m) to about 500 T/m. For the embodiment shown, the polymer material from which each filament 25a, 25b is formed is nylon 66 industrial filament. More than one filament 25 may be used in forming a respective first strand 24.

As seen across schematics “B” and “C”, multiple formed first strands 24 are then used to form a single yarn. The formed yarn provides an instance of the second strand 23 (the second strand 23a shown specifically at schematic “B”). For the embodiment shown, each second strand 23 comprises an assembly of five first strands 24a-24e that are assembled together in a manner (e.g. by twisting together) so as to form a respective second strand 23. The formed second strand 23 may be described in the form “1870 dtex/2*5”. In an embodiment, assembly of each second strand 23 involves ply-twisting the first strands 24a-24e together so that the twist degree implemented in each formed second strand 23 is caused to be in a range from about 30 T/m to about 300 T/m.

An instance or strand of the fabric cord 22 is then formed from an assembly of multiple second strands 23a-23e. In the embodiment shown in FIG. 5, the fabric cord 22 comprises an assembly of five second strands 23a-23e assembled together in a manner (e.g. by twisting together) so that the twist degree implemented in the resulting formed fabric cord 22 is caused to be in a range from about 30 T/m to about 300 T/m. The formed second strand 23 may be described in the form “1870 dtex/2*5*5”. In one embodiment, the assembly of the second strands 23a-23e are double-twisted so as to achieve the desired twist degree.

In terms of adhesion to the surrounding rubber segment 18 of the conveyor belt 10 for production purposes, for the embodiment described above, if dipped nylon based filament/fibre is used as the base or primary filament (e.g. for filaments 25a, 25b), it may be usable for production after being packaged without further treatment being required. Alternatively, if ordinary nylon industrial filament is used, it may be necessary to pass the finished fabric cord 22 through a surface treatment process in order to enable the fabric cord 22 to be capable of bonding to the rubber segment 18. In an embodiment, such a surface treatment process may involve use of appropriate cord dipping equipment/machinery.

Performance testing of prototype embodiments of conveyor belts 10 formed consistent with the principles described herein have shown advantage over conventional steel cord conveyor belts. Such advantages appear significant when considering modes of failure referred to as ‘edge cracking’, where the outer disposed steel cords need to travel further than the centrally disposed cords, often resulting in either overload failure or fatigue failure depending on the size of the change in distance travelled.

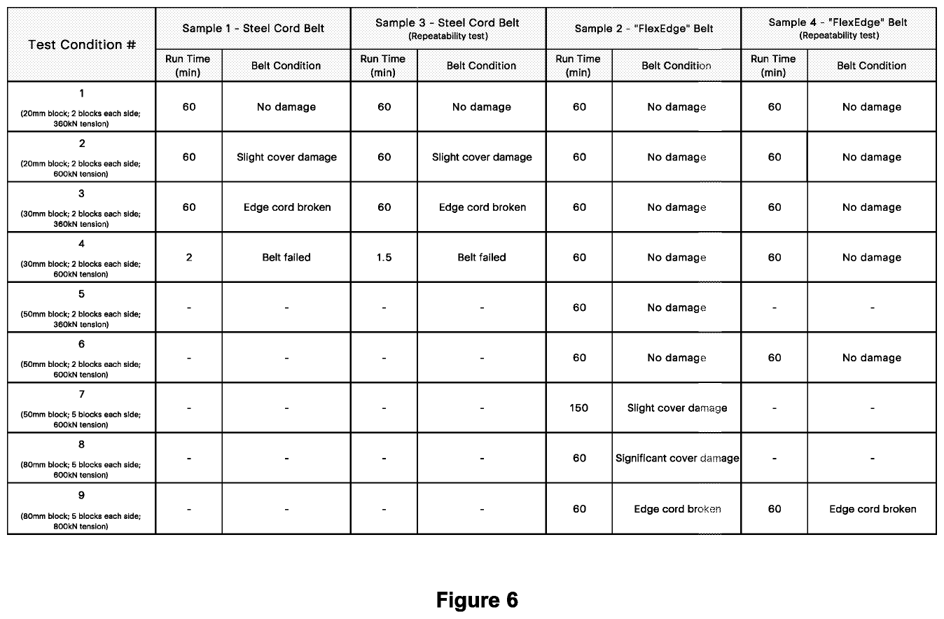

For one testing program where the performance of standard conveyor belts using standard steel cord arrangements was compared with conveyor belts formed consistent with the presently described principles, testing was carried out using a purpose-built rig to enable running of the sample belts about spaced apart opposing standard pulley arrangements. To induce tension forces in the edge or side portions (14) of the sample conveyor belts, blocks of varying height (aligned radially relative to the centre of the pulley) were installed on each side of at least one of the pulley arrangements to force the edge/side portions (14) of the sample conveyor belts to travel further relative to the respective central portions (12). The results of this performance testing program are shown in tabulated form in FIG. 6, where sample conveyor belts arranged in accordance with the present principles using fabric cords 22 are referred to as ‘FlexEdge’.

The findings reported in the table shown in FIG. 6 can be interpreted in two primary ways: (a) from an energy perspective where work energy as a factor of the tension and the block height difference are both considered, and (b) a fatigue perspective. Having regard to the energy perspective it was considered that the FlexEdge belt absorbed in the order of about 5.9 times more energy at the point of failure than the conventional conveyor belt sample configurations. From the fatigue perspective, the amount of cycles per rotation are first reviewed with the FlexEdge conveyor belt samples having three cycles per belt rotation, with the steel cord conveyor belt samples having 1. With a sample conveyor belt performing a rotation about every 11 seconds, it was considered that that FlexEdge completed in the order of about 675× more cycles than the steel cord conveyor belt samples when comparing, for example, the FlexEdge conveyor belt sample test case “9” and the steel cord conveyor belt sample test case “3” where the same or similar damage occurred. Accordingly, advantages in performance of the FlexEdge conveyor belt samples was demonstrated as compared the conventionally formed steel cord conveyor belt samples.

The disclosure also provides a conveyor belt system comprising conveyor belt 10 and/or use of the conveyor belt 10 to transport material.

In the claims that follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

Furthermore, in the claims that follow and in the preceding description, except where the context requires otherwise due to express language or necessary implication, the word “include” or variations such as “includes” or “including” is used in an inclusive sense, i.e. to specify the presence of the stated features but not to preclude the presence or addition of further features in various embodiments.

Modifications and variations as would be apparent to a skilled addressee are deemed to be within the scope of the present disclosure.

1-26. (canceled)

27. A conveyor belt comprising:
a middle region having embedded steel cords extending along a longitudinal direction of the conveyor belt; and
side regions disposed laterally on either side of the middle region, each side region having embedded non-steel reinforcing members of fabric cord extending along a longitudinal direction of the conveyor belt;
wherein the non-steel fabric cord reinforcing members comprise more than one assembly of constituent strands or filaments of a polymer-based material assembled together for conferring the non-steel fabric cord reinforcing members with a lower elastic modulus than the steel cords to allow the side regions to absorb in-use stresses induced by edge tension through elastic deformation.

28. A conveyor belt as claimed in claim 27, wherein the induced in-use stresses absorbed by the side regions are higher than those experienced by the other regions of the conveyor belt.

29. A conveyor belt as claimed in claim 27, wherein a pitch of the steel cords and the non-steel fabric cord reinforcing members is the same.

30. A conveyor belt as claimed in claim 27, wherein a diameter of the steel cords and the non-steel fabric cord reinforcing members is the same.

31. A conveyor belt as claimed in claim 27, wherein the non-steel fabric cord reinforcing members are polymer-based, or comprise a polyester, a polyamide, and/or an aramid, either individually or in combination.

32. A conveyor belt as claimed in claim 27, wherein the non-steel fabric cord reinforcing members comprise more than one first strands assembled together, the or each first strand formed by an assembly of more than one filaments or fibres of a polymer material assembled together.

33. A conveyor belt as claimed in claim 31, wherein the or each filament or fibre of polymer material has a fineness of about 1870 dtex.

34. A conveyor belt as claimed in claim 27, wherein the or each first strand comprises a twist degree that is in a range from about 90 twists per metre to about 500 twists per metre.

35. A conveyor belt as claimed in claim 27, wherein the non-steel fabric cord reinforcing members comprise more than one second strands assembled together, the or each second strand formed by an assembly of more than one first strands assembled together.

36. A conveyor belt as claimed in claim 35, wherein assembly of the first strands is undertaken so as to implement in a respectively formed second strand a twist degree that is in a range from about 30 twists per metre to about 300 twists per metre.

37. A conveyor belt as claimed in claim 35, wherein assembly of the second strands is undertaken so as to implement in a respectively formed non-steel fabric cord reinforcing member a twist degree that is in a range from about 30 twists per metre to about 300 twists per metre.

38. A conveyor belt as claimed in claim 27, wherein the or each filament or fibre of the first strand is treated so as to enable or facilitate structural bonding with a material forming one or more regions of the conveyor belt.

39. A conveyor belt as claimed in claim 27, wherein the non-steel fabric cord reinforcing members are treated so as to enable or facilitate structural bonding with a material forming one or more regions of the conveyor belt.

40. A conveyor belt as claimed in claim 27, wherein the middle region and the side regions are formed from rubber.

41. A conveyor belt as claimed in claim 40, wherein the non-steel fabric cord reinforcing members in the side regions are structurally bonded to the rubber.

42. A conveyor belt as claimed in claim 27, wherein the middle region has about 5 to about 10 times as many steel cords compared to the number of non-steel fabric cord reinforcing members in each side region, and/or the number of steel cords ranges from 50 to 100, and/or the number of non-steel fabric cord reinforcing members ranges from about 5 to about 20.

43. A conveyor belt as claimed in claim 27, wherein the middle region occupies from about 50% to about 80% of a width of the conveyor belt.

44. A conveyor belt as claimed in claim 27, wherein each side region occupies from about 10% to about 25% of the width of the conveyor belt.

45. A conveyor belt as claimed in claim 27, wherein each side region comprises an edge section free from non-steel fabric cord reinforcing members to define an edge width of the conveyor belt, and/or the edge width occupies from about 15 mm up to about 50 mm of a width of the conveyor belt.

46. A conveyor belt as claimed in claim 27, wherein the middle region has a first thickness and the side regions have a second thickness located at an edge of each side region, the side regions tapering down from the first thickness to the second thickness, and/or the second thickness is in a range from between about 65% to about 85% of the first thickness.
